(19) United States
(12) Patent Application Publication
(10) Pub. No.: US 2025/0353168 A1
(43) Pub. Date: Nov. 20, 2025

(54) LEARNING FROM DEMONSTRATION (LfD) VIA PHYSICAL HUMAN-ROBOT-HUMAN INTERACTIONS

(71) Applicant: Honda Motor Co., Ltd., Tokyo (JP)

(72) Inventors: Keyvan MAJD, Ann Arbor, MI (US); Rana SOLTANI ZARRIN, Los Gatos, CA (US)

(21) Appl. No.: 19/013,474

(22) Filed: Jan. 8, 2025

Related U.S. Application Data
(60) Provisional application No. 63/648,012, filed on May 15, 2024.

(51) Int. Cl. B25J 9/16

(52) U.S. Cl. CPC B25J 9/163

(57) ABSTRACT

According to one aspect, a learning from demonstration (LfD) via physical human-robot-human (pHRH) interactions may include generating a command corresponding to an operation input received from a first human indicative of a desired command to be performed by a robot for LfD via pHRH interactions subject to one or more constraints, implementing the command via an actuator and a robot appendage to create a pHRH interaction between the robot for LfD via pHRH interactions and a second human, and training a model for the robot for LfD via pHRH interactions based on the pHRH interaction.

### CROSS-REFERENCE TO RELATED APPLICATIONS

This application claims the benefit of U.S. Provisional Patent Application, Ser. No. 63/648,012 (Attorney Docket No. HRA-56049) entitled “LEARNING FROM DEMONSTRATION VIA PHYSICAL HUMAN-ROBOT-HUMAN INTERACTIONS”, filed on May 15, 2024; the entirety of the above-noted application(s) is incorporated by reference herein.

### BACKGROUND

Robot learning from demonstration (LfD) or robot programming by demonstration (PbD) is a paradigm for enabling robots to autonomously perform new tasks. Rather than requiring users to analytically decompose and manually program a desired behavior, work in LfD-PbD takes the view that an appropriate robot controller can be derived from observations of a human's own performance thereof. The aim is for robot capabilities to be more easily extended and adapted to novel situations, even by users without programming ability.

### BRIEF DESCRIPTION

According to one aspect, a system for learning from demonstration (LfD) via physical human-robot-human (pHRH) interactions may include a processor and a memory. The memory may store one or more instructions. The processor may execute one or more of the instructions stored on the memory to perform one or more acts, actions, and/or steps. For example, the processor may perform generating a command corresponding to an operation input received from a first human indicative of a desired command to be performed by the system for LfD via pHRH interactions subject to one or more constraints, implementing the command via an actuator and a robot appendage to create a pHRH interaction between the system for LfD via pHRH interactions and a second human, and training a model for the system for LfD via pHRH interactions based on the pHRH interaction.

The system for LfD via pHRH interactions may include the actuator and the robot appendage. The system for LfD via pHRH interactions may include a communication interface receiving the operation input associated with the first human indicative of the desired command to be performed by the system for LfD via pHRH interactions. The first human may be located remotely from the system for LfD via pHRH interactions. A remote system for LfD via pHRH interactions may generate and implement a remote command corresponding to the command via a remote actuator and a remote robot appendage to implement a movement corresponding to the pHRH interaction between the system for LfD via pHRH interactions and the second human. The processor may repair a neural network associated with the model for the system for LfD via pHRH interactions based on the pHRH interaction. One or more of the constraints may be a force constraint, an acceleration constraint, a velocity constraint, a proximity constraint, a joint angle constraint associated with the robot appendage, or an interaction constraint. The desired command associated with the operation input may be a wound care command, a physical rehabilitation command, a movement command, or a carrying command. The system for LfD via pHRH interactions may include a sensor sensing a characteristic associated with the pHRH interaction between the system for LfD via pHRH interactions and the second human. The processor may train the model for the system for LfD via pHRH interactions based on the characteristic.

According to one aspect, a computer-implemented method for learning from demonstration (LfD) via physical human-robot-human (pHRH) interactions may include generating a command corresponding to an operation input received from a first human indicative of a desired command to be performed by a robot for LfD via pHRH interactions subject to one or more constraints, implementing the command via an actuator and a robot appendage to create a pHRH interaction between the robot for LfD via pHRH interactions and a second human, and training a model for the robot for LfD via pHRH interactions based on the pHRH interaction.

The computer-implemented method for LfD via pHRH interactions may include receiving the operation input associated with the first human indicative of the desired command to be performed by the robot for LfD via pHRH interactions. The first human may be located remotely from the robot for LfD via pHRH interactions. A remote system for LfD via pHRH interactions may generate and implement a remote command corresponding to the command via a remote actuator and a remote robot appendage to implement a movement corresponding to the pHRH interaction between the robot for LfD via pHRH interactions and the second human. The computer-implemented method for LfD via pHRH interactions may include repairing a neural network associated with the model for the robot for LfD via pHRH interactions based on the pHRH interaction.

According to one aspect, a robot for learning from demonstration (LfD) via physical human-robot-human (pHRH) interactions may include a processor and a memory. The memory may store one or more instructions. The processor may execute one or more of the instructions stored on the memory to perform one or more acts, actions, and/or steps. For example, the processor may perform generating a command corresponding to an operation input received from a first human indicative of a desired command to be performed by the robot for LfD via pHRH interactions subject to one or more constraints, implementing the command via an actuator and a robot appendage to create a pHRH interaction between the robot for LfD via pHRH interactions and a second human, and training a model for the robot for LfD via pHRH interactions based on the pHRH interaction.

The robot for LfD via pHRH interactions may include the actuator and the robot appendage. The robot for LfD via pHRH interactions may include a communication interface receiving the operation input associated with the first human indicative of the desired command to be performed by the robot for LfD via pHRH interactions. The first human may be located remotely from the robot for LfD via pHRH interactions. A remote system for LfD via pHRH interactions may generate and implement a remote command corresponding to the command via a remote actuator and a remote robot appendage to implement a movement corresponding to the pHRH interaction between the robot for LfD via pHRH interactions and the second human.

### BRIEF DESCRIPTION OF THE DRAWINGS

FIG. 1 is an exemplary component diagram of a system for learning from demonstration (LfD) via physical human-robot-human (pHRH) interactions, according to one aspect.

FIG. 2 is an exemplary scenario associated with learning from demonstration (LfD) via physical human-robot-human (pHRH) interactions, according to one aspect.

FIG. 3 is an exemplary flow diagram of a computer-implemented method for learning from demonstration (LfD) via physical human-robot-human (pHRH) interactions, according to one aspect.

FIG. 4 is an illustration of an example computing environment where one or more of the provisions set forth herein are implemented, according to one aspect.

FIG. 5 is an illustration of an example computer-readable medium or computer-readable device including processor-executable instructions configured to embody one or more of the provisions set forth herein, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein, may be combined, omitted, or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “database”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “mobile device”, as used herein, may be a computing device typically having a display screen with a user input (e.g., touch, keyboard) and a processor for computing. Mobile devices include handheld devices, portable electronic devices, smart phones, laptops, tablets, and e-readers.

A “robot”, as used herein, may be a machine, such as one programmable by a computer, and capable of carrying out a complex series of actions automatically. A robot may be guided by an external control device or the control may be embedded within a controller. It will be appreciated that a robot may be designed to perform a task with no regard to appearance. Therefore, a ‘robot’ may include a machine which does not necessarily resemble a human, including a vehicle, a device, a flying robot, a manipulator, a robotic arm, etc.

A “robot system”, as used herein, may be any automatic or manual systems that may be used to enhance robot performance. Exemplary robot systems include a motor system, an autonomous driving system, an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a suspension system, an audio system, a sensory system, among others.

Learning from demonstration (LfD) via physical human-robot-human (pHRH) interactions is described herein. According to one aspect, a first human may teleoperate a first robot. A second robot may, to some extent possible, mirror actions of commands given to the first robot and based on these actions, create a physical robot-human interaction between the second robot and a second human. In this way, a physical human-robot-human interaction may be generated. A system for learning from demonstration (LfD) via physical human-robot-human (pHRH) interactions may utilize the pHRH interaction as a learning from demonstration (LfD) to train a model for the second robot, for example. In this way, tasks, sub-tasks, behavior cloning, etc. may be trained for the second robot and stored in a library for future use, for example. Further, the benefit or advantage of enabling LfD in a remote setting is provided since the first human and the first robot are not necessarily required to be co-located with the second human and the second robot.

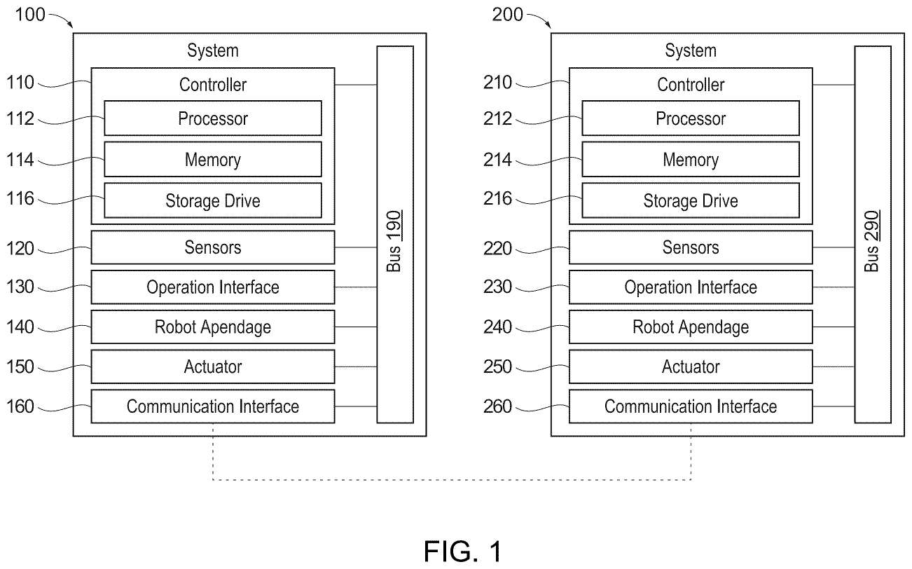

FIG. 1 is an exemplary component diagram of a system 100 for learning from demonstration (LfD) via physical human-robot-human (pHRH) interactions, according to one aspect. The system 100 for LfD via pHRH interactions may include a controller 110. The controller 110 may include a processor 112, a memory 114, and a storage drive 116. The system 100 for LfD via pHRH interactions may include one or more sensors 120, an operation interface 130, a robot appendage 140, one or more actuators 150, a communication interface 160, and a bus 190.

One or more components of the system 100 for LfD via pHRH interactions (e.g., a first robot) may be operably connected or communicatively coupled by the bus 190 to enable computer communication therebetween. For example, the bus 190 may operably connect or communicatively couple the controller 110, one or more of the sensors 120, the operation interface 130, the robot appendage 140, one or more of the actuators 150, and the communication interface 160. The memory 114 may store one or more instructions. The processor 112 may execute one or more of the instructions stored on the memory 114 to perform one or more acts, actions, and/or steps.

Additionally, a remote system 200 for LfD via pHRH interactions (e.g., a second robot) may include a controller 210. The controller 210 may include a processor 212, a memory 214, and a storage drive 216. The remote system 200 for LfD via pHRH interactions may include one or more sensors 220, an operation interface 230, a robot appendage 240, one or more actuators 250, a communication interface 260, and a bus 290.

One or more components of the remote system 200 for LfD via pHRH interactions may be operably connected or communicatively coupled by the bus 290 to enable computer communication therebetween. For example, the bus 290 may operably connect or communicatively couple the controller 210, one or more of the sensors 220, the operation interface 230, the robot appendage 240, one or more of the actuators 250, and the communication interface 260. The memory 214 may store one or more instructions. The processor 212 may execute one or more of the instructions stored on the memory 214 to perform one or more acts, actions, and/or steps.

According to one aspect, the sensors 220 and operation interface 230 of the remote system 200 for LfD via pHRH interactions may receive an operation input associated with a first human indicative of a desired command to be performed by the system 100 for LfD via pHRH interactions. In other words, a human may utilize the sensors 220 and operation interface 230 or one or more of the sensors 220 to provide the operation input at the remote system 200 for LfD via pHRH interactions. The operation input may be representative of an “expert command” to facilitate LfD by the system 100 for LfD via pHRH interactions. The operation input may represent a human-level skill, such as wiping a wound area, dressing a wound area, co-carrying an object, assisting a patient with a task, massaging an area, stretching a portion of a patient, etc. The first human and the remote system 200 for LfD via pHRH interactions may be located remotely from the system 100 for LfD via pHRH interactions and a second human. The processor 212 for the remote system 200 for LfD via pHRH interactions may generate and implement a remote command based on the operation input indicative of the desired command.

According to one aspect, the robot appendage 240 and/or the remote system 200 for LfD via pHRH interactions may be associated with one or more constraints. The robot appendage 240 may be a robotic hand, a robotic arm, etc. In this regard, the remote command may be implemented subject to one or more of these constraints in association with the robot appendage 240 and/or the remote system 200 for LfD via pHRH interactions.

The communication interface 260 of the remote system 200 for LfD via pHRH interactions may transmit the command to the communication interface 160 of the system 100 for LfD via pHRH interactions, which may then pass the remote command to the processor 112 to be implemented as the command. The processor 112 of the system 100 for LfD via pHRH interactions may generate a command corresponding to the operation input received from the first human indicative of the desired command to be performed by the system 100 for LfD via pHRH interactions subject to one or more constraints based on the remote command.

According to one aspect, the desired command associated with the operation input may be a wound care command, a physical rehabilitation command, a movement command, or a carrying command. As described herein, a constraint of one or more of the constraints may be a force constraint, an acceleration constraint, a velocity constraint, a proximity constraint, a joint angle constraint associated with the robot appendage 140, a joint angle constraint associated with a human (e.g., the second human involved in the pHRH interaction with the second robot or the remote system 200 for LfD via pHRH interactions), an interaction constraint, a stability constraint, a preference, a threshold, an end effect constraint, etc. For example, the first human or the operator may exert any amount of force he or she desires to the operation interface 230, but after the command is received by communication interface 160 of the system 100 for LfD via pHRH interactions, the corresponding command may be implemented subject to a force constraint to limit any forces experienced by the second human, for example.

The command may correspond to the remote command implemented by the actuator 250 and the robot appendage 240 of the remote system 200 for LfD via pHRH interactions to implement a movement corresponding to the pHRH interaction between the system 100 for LfD via pHRH interactions and the second human. The processor 112 of the system 100 for LfD via pHRH interactions may receive the remote command from the remote system 200 for LfD via pHRH interactions via the communication interfaces 160, 260 and implement the remote command as the command (e.g., subject to local constraints or modifications) via the actuator 150 and the robot appendage 140 to create a pHRH interaction between the system 100 for LfD via pHRH interactions and the second human. The robot appendage 240 may be a robotic hand, a robotic arm, etc. In this way, the processor 112 may command the robot appendage 140 to move or operate in accordance with the command or remote command via the actuator 150 to create an interaction or pHRH interaction with the second human.

For example, an operator or the first user may operate the remote system 200 for LfD via pHRH interactions, optionally causing the robot appendage 240 and actuators 250 of the remote system 200 for LfD via pHRH interactions to implement a corresponding remote command. The remote command may be passed from the communication interface 260 of the remote system 200 for LfD via pHRH interactions to the communication interface 160 of the system 100 for LfD via pHRH interactions. The system 100 for LfD via pHRH interactions may transform this remote command into a command or a local command for implementation at the system 100 for LfD via pHRH interactions. The command may be implemented via the robot appendage 140 and the actuators 150. In implementing the command, a pHRH interaction may be created between the system 100 for LfD via pHRH interactions and the second human.

In this way, the processor 112 of the system 100 for LfD via pHRH interactions may train a model for the system 100 for LfD via pHRH interactions based on the pHRH interaction. According to one aspect, the processor 112 may change, repair, adjust, prune, or update a neural network or a policy associated with the model for the system 100 for LfD via pHRH interactions based on the pHRH interaction or human responses associated with the pHRH interaction. The model, the neural network, or the policy may be stored on the storage drive 116, according to one aspect.

The system 100 for LfD via pHRH interactions may include one or more sensors 120 sensing a characteristic associated with the pHRH interaction between the system 100 for LfD via pHRH interactions and the second human. For example, a sensor of the one or more sensors 120 may sense feedback from the second human indicative of one or more user preferences. The processor 112 may train the model for the system 100 for LfD via pHRH interactions based on the characteristic. In this way, the advantage or benefit of a remote LfD using the pHRH while incorporating desired preferences or features while using neural network repair may be provided because LfD experts may not necessarily be available locally to the second human. This enables the capture of meaningful data in an efficient manner compared to direct kinesthetic demonstration.

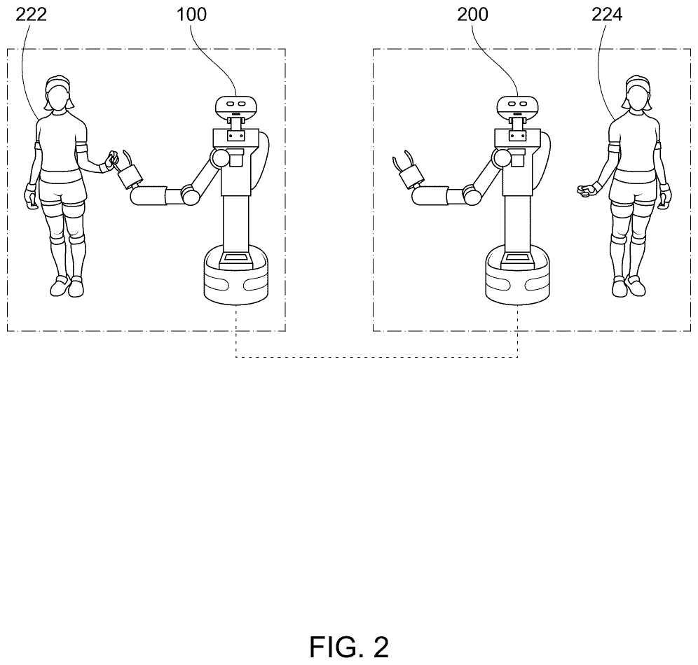

FIG. 2 is an exemplary scenario associated with learning from demonstration (LfD) via physical human-robot-human (pHRH) interactions, according to one aspect. As seen in FIG. 2, a first user 222 may interact with the first robot or the system 100 for LfD via pHRH interactions and a second user 224 may interact with the second robot or the remote system 200 for LfD via pHRH interactions.

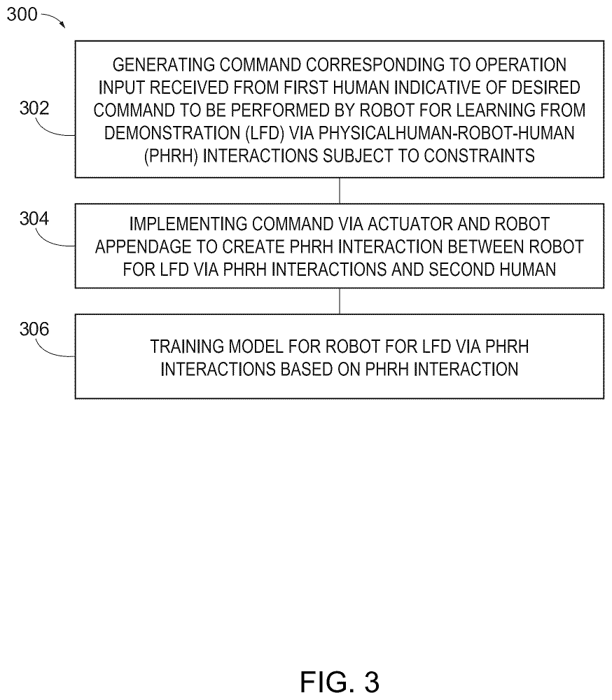

FIG. 3 is an exemplary flow diagram of a computer-implemented method 300 for learning from demonstration (LfD) via physical human-robot-human interactions (pHRH), according to one aspect. According to one aspect, the computer-implemented method for LfD via pHRH interactions may include receiving the operation input associated with the first human indicative of the desired command to be performed by the robot for LfD via pHRH interactions. The computer-implemented method 300 for LfD via pHRH interactions may include generating 302 a command corresponding to an operation input received from a first human (e.g., located remotely from the robot for LfD via pHRH interactions) indicative of a desired command to be performed by a robot for LfD via pHRH interactions subject to one or more constraints, implementing 304 the command via an actuator and a robot appendage to create a pHRH interaction between the robot for LfD via pHRH interactions and a second human, and training 306 a model for the robot for LfD via pHRH interactions based on the pHRH interaction.

According to one aspect, a remote system for LfD via pHRH interactions may generate and implement a remote command corresponding to the command via a remote actuator and a remote robot appendage to implement a movement corresponding to the pHRH interaction between the robot for LfD via pHRH interactions and the second human. Additionally, the computer-implemented method 300 for LfD via pHRH interactions may include repairing a neural network associated with the model for the robot for LfD via pHRH interactions based on the pHRH interaction.

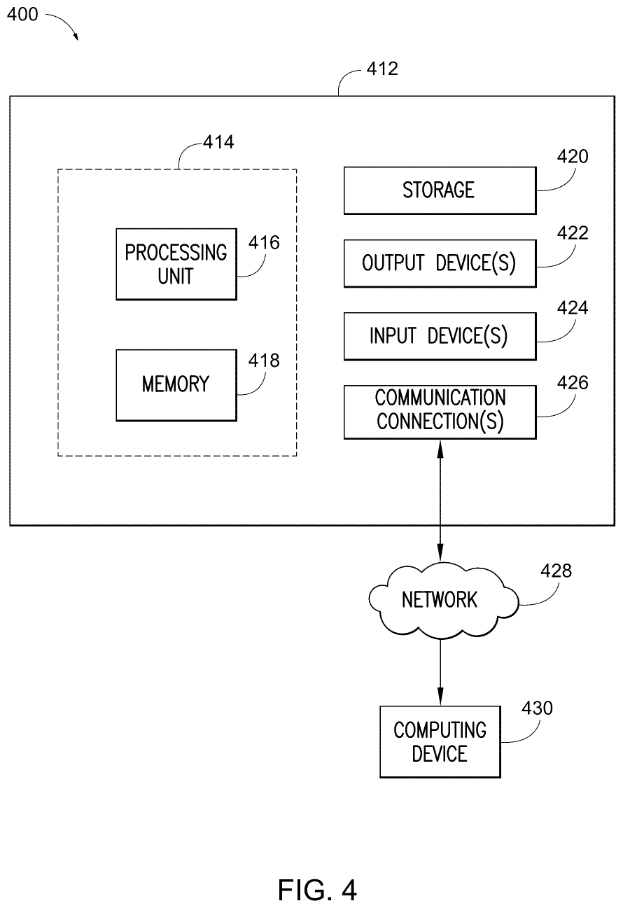

FIG. 4 and the following discussion provide a description of a suitable computing environment to implement aspects of one or more of the provisions set forth herein. The operating environment of FIG. 4 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 4 illustrates a system 400 including a computing device 412 configured to implement one aspect provided herein. In one configuration, the computing device 412 includes at least one processing unit 416 and memory 418. Depending on the exact configuration and type of computing device, memory 418 may be volatile, such as RAM, non-volatile, such as ROM, flash memory, etc., or a combination of the two. This configuration is illustrated in FIG. 4 by dashed line 414.

In other aspects, the computing device 412 includes additional features or functionality. For example, the computing device 412 may include additional storage such as removable storage or non-removable storage, including, but not limited to, magnetic storage, optical storage, etc. Such additional storage is illustrated in FIG. 4 by storage 420. In one aspect, computer readable instructions to implement one aspect provided herein are in storage 420. Storage 420 may store other computer readable instructions to implement an operating system, an application program, etc. Computer readable instructions may be loaded in memory 418 for execution by the at least one processing unit 416, for example.

The term “computer readable media” as used herein includes computer storage media. Computer storage media includes volatile and nonvolatile, removable, and non-removable media implemented in any method or technology for storage of information such as computer readable instructions or other data. Memory 418 and storage 420 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 412. Any such computer storage media is part of the computing device 412.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 412 includes input device(s) 424 such as keyboard, mouse, pen, voice input device, touch input device, infrared cameras, video input devices, or any other input device. Output device(s) 422 such as one or more displays, speakers, printers, or any other output device may be included with the computing device 412. Input device(s) 424 and output device(s) 422 may be connected to the computing device 412 via a wired connection, wireless connection, or any combination thereof. In one aspect, an input device or an output device from another computing device may be used as input device(s) 424 or output device(s) 422 for the computing device 412. The computing device 412 may include communication connection(s) 426 to facilitate communications with one or more other devices 430, such as through network 428, for example.

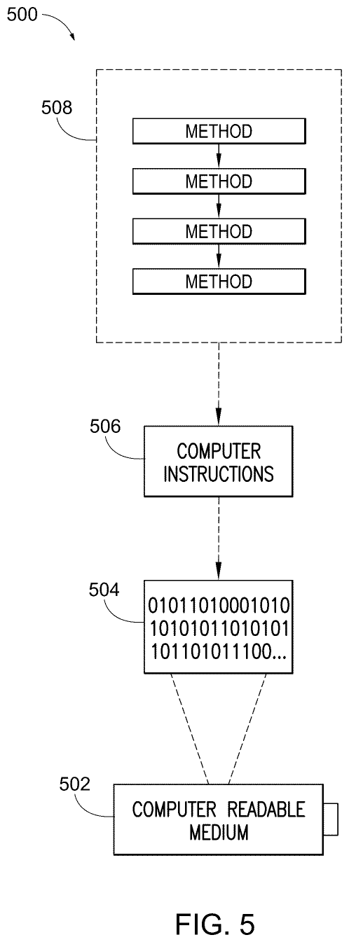

Still another aspect involves a computer-readable medium including processor-executable instructions configured to implement one aspect of the techniques presented herein. An aspect of a computer-readable medium or a computer-readable device devised in these ways is illustrated in FIG. 5, wherein an implementation 500 includes a computer-readable medium 502, such as a CD-R, DVD-R, flash drive, a platter of a hard disk drive, etc., on which is encoded computer-readable data 504. This encoded computer-readable data 504, such as binary data including a plurality of zero's and one's as shown in 504, in turn includes a set of processor-executable computer instructions 506 configured to operate according to one or more of the principles set forth herein. In this implementation 500, the processor-executable computer instructions 506 may be configured to perform a method 508, such as the computer-implemented method 300 for learning from demonstration via physical human-robot-human interactions of FIG. 3. In another aspect, the processor-executable computer instructions 506 may be configured to implement a system, such as the system 100 for learning from demonstration via physical human-robot-human interactions of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A system for learning from demonstration (LfD) via physical human-robot-human (pHRH) interactions, comprising:
a memory storing one or more instructions; and
a processor executing one or more of the instructions stored on the memory to perform:
generating a command corresponding to an operation input received from a first human indicative of a desired command to be performed by the system for LfD via pHRH interactions subject to one or more constraints;
implementing the command via an actuator and a robot appendage to create a pHRH interaction between the system for LfD via pHRH interactions and a second human; and
training a model for the system for LfD via pHRH interactions based on the pHRH interaction.

2. The system for LfD via pHRH interactions of claim 1, comprising the actuator and the robot appendage.

3. The system for LfD via pHRH interactions of claim 1, comprising a communication interface receiving the operation input associated with the first human indicative of the desired command to be performed by the system for LfD via pHRH interactions.

4. The system for LfD via pHRH interactions of claim 1, wherein the first human is located remotely from the system for LfD via pHRH interactions.

5. The system for LfD via pHRH interactions of claim 1, wherein a remote system for LfD via pHRH interactions generates and implements a remote command corresponding to the command via a remote actuator and a remote robot appendage to implement a movement corresponding to the pHRH interaction between the system for LfD via pHRH interactions and the second human.

6. The system for LfD via pHRH interactions of claim 1, wherein the processor repairs a neural network associated with the model for the system for LfD via pHRH interactions based on the pHRH interaction.

7. The system for LfD via pHRH interactions of claim 1, wherein one or more of the constraints is a force constraint, an acceleration constraint, a velocity constraint, a proximity constraint, a joint angle constraint associated with the robot appendage, or an interaction constraint.

8. The system for LfD via pHRH interactions of claim 1, wherein the desired command associated with the operation input is a wound care command, a physical rehabilitation command, a movement command, or a carrying command.

9. The system for LfD via pHRH interactions of claim 1, comprising a sensor sensing a characteristic associated with the pHRH interaction between the system for LfD via pHRH interactions and the second human.

10. The system for LfD via pHRH interactions of claim 9, wherein the processor trains the model for the system for LfD via pHRH interactions based on the characteristic.

11. A computer-implemented method for learning from demonstration (LfD) via physical human-robot-human (pHRH) interactions, comprising:
generating a command corresponding to an operation input received from a first human indicative of a desired command to be performed by a robot for LfD via pHRH interactions subject to one or more constraints;
implementing the command via an actuator and a robot appendage to create a pHRH interaction between the robot for LfD via pHRH interactions and a second human; and
training a model for the robot for LfD via pHRH interactions based on the pHRH interaction.

12. The computer-implemented method for LfD via pHRH interactions of claim 11, comprising receiving the operation input associated with the first human indicative of the desired command to be performed by the robot for LfD via pHRH interactions.

13. The computer-implemented method for LfD via pHRH interactions of claim 11, wherein the first human is located remotely from the robot for LfD via pHRH interactions.

14. The computer-implemented method for LfD via pHRH interactions of claim 11, wherein a remote system for LfD via pHRH interactions generates and implements a remote command corresponding to the command via a remote actuator and a remote robot appendage to implement a movement corresponding to the pHRH interaction between the robot for LfD via pHRH interactions and the second human.

15. The computer-implemented method for LfD via pHRH interactions of claim 11, comprising repairing a neural network associated with the model for the robot for LfD via pHRH interactions based on the pHRH interaction.

16. A robot for learning from demonstration (LfD) via physical human-robot-human (pHRH) interactions, comprising:
a memory storing one or more instructions; and
a processor executing one or more of the instructions stored on the memory to perform:
generating a command corresponding to an operation input received from a first human indicative of a desired command to be performed by the robot for LfD via pHRH interactions subject to one or more constraints;
implementing the command via an actuator and a robot appendage to create a pHRH interaction between the robot for LfD via pHRH interactions and a second human; and
training a model for the robot for LfD via pHRH interactions based on the pHRH interaction.

17. The robot for LfD via pHRH interactions of claim 16, comprising the actuator and the robot appendage.

18. The robot for LfD via pHRH interactions of claim 16, comprising a communication interface receiving the operation input associated with the first human indicative of the desired command to be performed by the robot for LfD via pHRH interactions.

19. The robot for LfD via pHRH interactions of claim 16, wherein the first human is located remotely from the robot for LfD via pHRH interactions.

20. The robot for LfD via pHRH interactions of claim 16, wherein a remote system for LfD via pHRH interactions generates and implements a remote command corresponding to the command via a remote actuator and a remote robot appendage to implement a movement corresponding to the pHRH interaction between the robot for LfD via pHRH interactions and the second human.
